(19) United States
(12) Patent Application Publication
(10) Pub. No.: US 2024/0027286 A1
(43) Pub. Date: Jan. 25, 2024

(54) SENSOR FOR DETECTING A TORQUE

(71) Applicants: Martin WISCHKE, München (DE); Peter MÜLLER, München (DE); Bourns, Inc., Riverside, CA (US)

(72) Inventors: Peter Müller, Munich (DE); Martin Wischke, Munich (DE)

(21) Appl. No.: 17/995,351

(22) PCT Filed: Apr. 6, 2021
(86) PCT No.: PCT/IB2021/052859

§ 371 Date: Oct. 3, 2022

(30) Foreign Application Priority Data
Apr. 3, 2020 (DE) 10 2020 109 469.8

(51) Int. Cl. G01L 3/10; G01L 5/22; B62D 6/10

(52) U.S. Cl. CPC G01L 3/104; G01L 5/221; B62D 6/10

(57) ABSTRACT

The invention relates to a sensor (9) for detecting a torque (13) exerted on a torsion element (10) and acting about an axis of rotation (8), comprising:
a transmitter element (16) which can be mounted in a stationary manner relative to a first axial end of the torsion element (10) and is designed to output a transmitting field (17) which can be varied in the peripheral direction (24) about the axis of rotation (8),
a sensor chip (18) which can be mounted in a stationary manner relative to a second end opposite the first axial end of the torsion element (10) and is designed to output a measurement signal (20) which is dependent on the transmitting field (17) arriving at the sensor chip (18), and
an evaluation device (21) which is designed to output a sensor signal (19) dependent on the torque (13) on the basis of the measurement signal (20),
wherein the sensor chip (18) is arranged at an axial distance from the transmitter element (16), radially overlapping same.

### DESCRIPTION

The present invention relates to a sensor for detecting a torque exerted on a torsion element and acting about an axis of rotation and a vehicle with the sensor.

A sensor for detecting a torque exerted on a torsion element and acting about an axis of rotation is known from EP 1 167 936 A2, comprising a transmitter element which can be mounted in a stationary manner relative to a first axial end of the torsion element and is designed to output a transmitting field which can be varied in the peripheral direction about the axis of rotation, a sensor chip which can be mounted in a stationary manner relative to a second end opposite the first axial end of the torsion element and is designed to output a measurement signal which is dependent on the transmitting field arriving at the sensor chip, and an evaluation device which is designed to output a sensor signal dependent on the torque on the basis of the measurement signal. In the sensor, the transmitter element and the sensor chip are arranged axially at the same height and radially spaced apart.

It is object of the invention to improve the known sensor.

The task is fulfilled by the characteristics of the independent claim. Preferred embodiments are the subject matter of the dependent claims.

According to an aspect of the invention, a sensor for detecting a torque exerted on a torsion element and acting about an axis of rotation comprises a transmitter element which can be mounted in a stationary manner relative to a first axial end of the torsion element and is designed to output a transmitting field which can be varied in the peripheral direction about the axis of rotation, a sensor chip which can be mounted in a stationary manner relative to a second end opposite the first axial end of the torsion element and is designed to output a measurement signal which is dependent on the transmitting field arriving at the sensor chip, and an evaluation device which is designed to output a sensor signal dependent on the torque on the basis of the measurement signal. The sensor chip is arranged at an axial distance from the transmitter element, radially overlapping same. This means that in the sensor according to the invention, the transmitter element and the sensor chip are arranged axially at the same height and radially spaced apart.

The specified sensor is based on the idea that the torsion element for detecting the torque is designed to be elastic. Due to the elasticity, the torsion element can be twisted with the torque about the rotational axis, whereby the relative position of the transmitter element to the sensor chip in the peripheral direction is dependent on the torque. Because the transmitting field is also variable in the peripheral direction around the axis of rotation, the output measurement signal is thus dependent on the torque. However, not only the torque acts on the torsion element during use, but also shear forces due to mechanical play, which result in a relative radial misalignment between the transmitter element and the sensor chip and change the transmitting field arriving at the sensor chip. This change leads to a change in the measurement signal and thus to an incorrect detection of the torque.

To avoid this error, it is therefore proposed with the specified sensor to position the sensor chip not radially to the transmitter element but axially to the transmitter element. This reduces the sensitivity of the sensor to the aforementioned shear forces and thus reduces errors in the detection of the torque.

In an embodiment of the specified sensor, the transmitter element is a magnet which emits a magnetic field as the transmitting field, whereby the sensor chip is designed to output the measurement signal as a function of the magnetic field arriving at the sensor chip. Magnetic fields can be generated primarily with magnets in the form of permanent magnets in the application without the supply of external energy, so that this form of transmitting fields can be implemented in a reliable, energy-efficient and space-saving manner.

In a particular embodiment of the specified sensor, the magnet is designed with a rectilinear shape and is arranged tangentially to the axis of rotation. Such magnets can be procured more economically because, for example, their shape makes them easier to stack for transport.

In a further embodiment of the specified sensor, a perpendicular foot point referred to the axis of rotation is arranged centrally on the magnet when the torque is zero. In this way, positive torques that rotate the torsion element in the positive direction of rotation and negative torques that rotate the torsion element in the negative direction of rotation can be detected with the magnet over a range of values of equal magnitude.

In a particularly preferred embodiment of the specified sensor, the rectilinear shape of the magnet is the shape of a bar magnet, which are particularly cost-effective economically due to their standard shape.

In another embodiment of the specified sensor, the sensor chip is movably arranged with respect to the bar magnet on a circular path leading around the axis of rotation, which, viewed axially, intersects end edges of the bar magnet with a distance of intersection from an edge of the bar magnet directed towards the axis of rotation, which is between 5% and 45%, preferably between 15% and 35% and particularly preferably between 20% and 30% of a distance of the end edges.

In yet another embodiment of the specified sensor, the circular path, viewed axially in the region covering the bar magnet, has, from the point of view of an edge of the bar magnet directed towards the axis of rotation, an extreme point which is spaced from the edge of the bar magnet directed towards the axis of rotation by an extreme point distance of between 5% and 45%, preferably between 15% and 35%, particularly preferably between 20% and 30% of the distance between the edge of the bar magnet directed towards the axis of rotation and the edge of the bar magnet directed away from the axis of rotation.

In an additional embodiment of the specified sensor, a movement of the sensor chip on the circular path from the point of view of the bar magnet is limited between two movement limiting points, each of which has a face side distance from the face side edges of the bar magnet of between 5% and 45%, preferably between 15% and 35% and particularly preferably between 20% and 30% of a distance of the face side edges.

In yet another embodiment of the specified sensor, the circular path in the area of the bar magnet is symmetrical with respect to a straight line passing through the perpendicular foot point and the axis of rotation.

According to another aspect of the present invention, a vehicle comprises a chassis movable in a driving direction, two front wheels supporting the chassis at the front as viewed in the driving direction, two rear wheels supporting the chassis at the rear as viewed in the driving direction, a steering wheel for rotating a steering shaft about an axis of rotation, for turning the front wheels, one of said sensors for detecting a torque exerted on the steering shaft with the steering wheel, and a motor for adjusting the turning of the front wheels in accordance with the detected torque.

The above-described properties, features and advantages of this invention, as well as the manner in which they are achieved, will become clearer in connection with the following description of the embodiments, which are explained in more detail in connection with the drawing, in which:

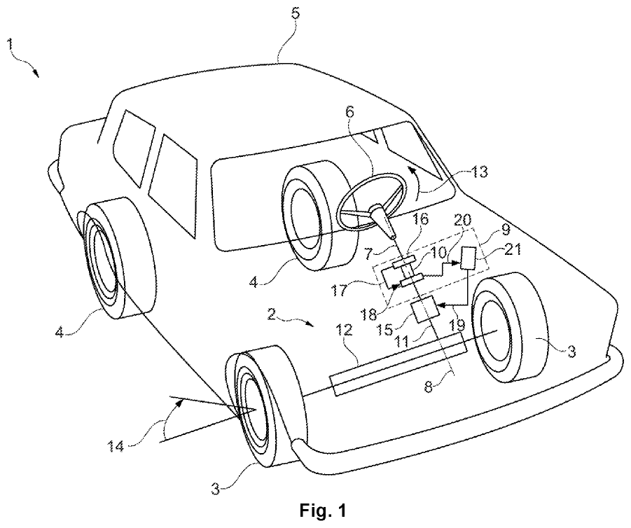

FIG. 1 is a schematic perspective view of a vehicle with a steering system,

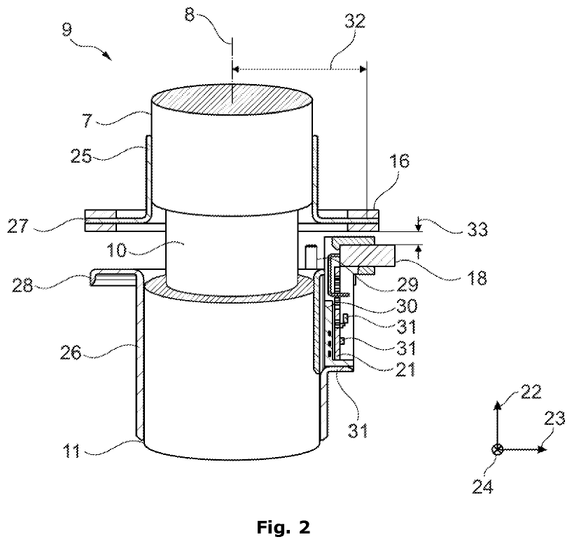

FIG. 2 is a schematic view of a first version of a torque sensor for the steering system from FIG. 1,

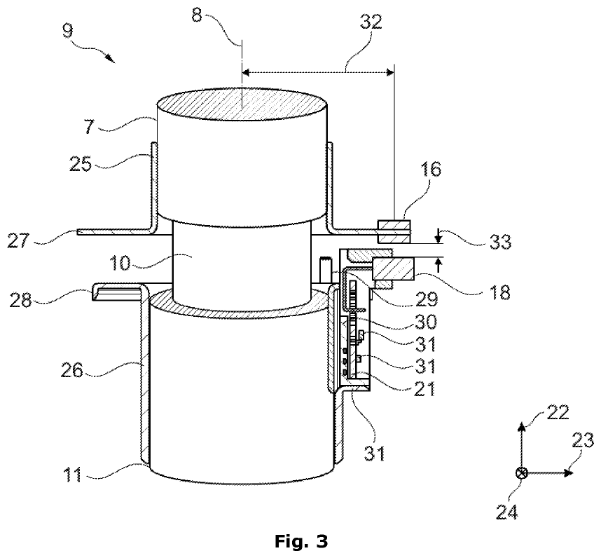

FIG. 3 is a schematic view of a second version of a torque sensor for the steering system from FIG. 1,

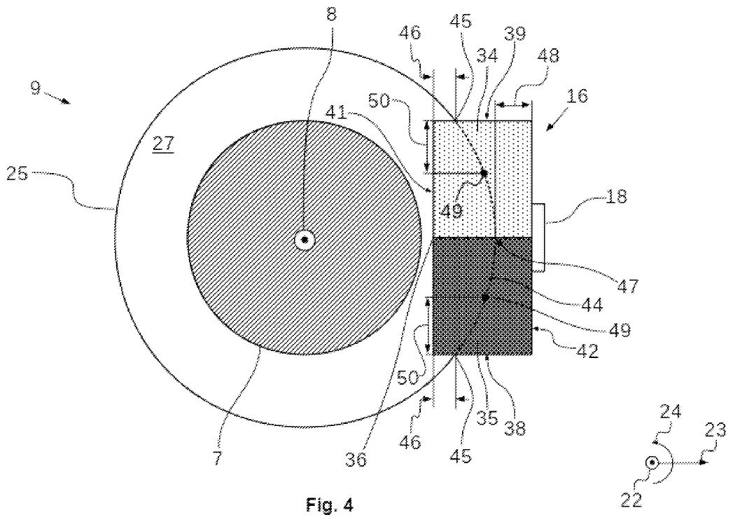

FIG. 4 is the torque sensor from FIG. 3 from a different perspective,

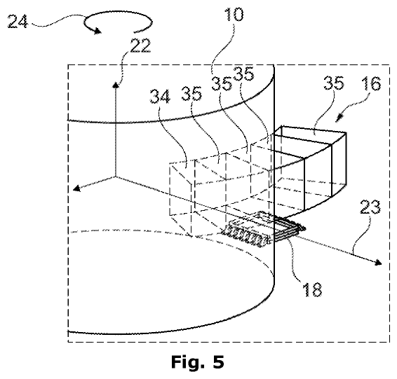

FIG. 5 is a sketch of a third version of a torque sensor for the steering system from FIG. 1, and

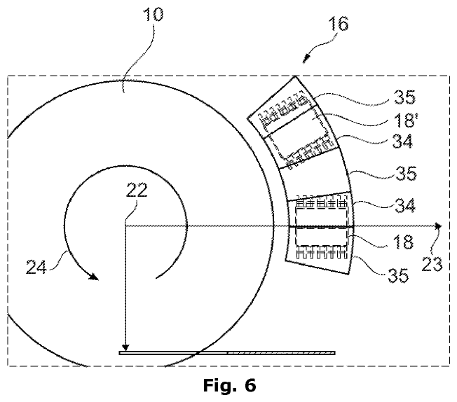

FIG. 6 is a sketch of an embodiment of the third version of the torque sensor according to FIG. 5, and

In the figures, the same technical elements are provided with the same reference signs, and are only described once. The figures are purely schematic and, in particular, do not reflect the actual geometric proportions.

Reference is made to FIG. 1, which is a schematic perspective view of a vehicle 1 comprising a steering system 2.

In the present embodiment, the vehicle 1 comprises a chassis 5 supported by two front wheels 3 and two rear wheels 4. The front wheels 3 can be turned by the steering system 2 so that the vehicle 1 can be driven in a curve.

The steering system 2 comprises a steering wheel 6 which is mounted on a first steering shaft 7, which in turn is mounted so as to be able to rotate a rotation axis 8. The first steering shaft 7 is guided into a torque sensor 9 and connected there to a torsion element 10 in a manner not further specified. A second steering shaft 11 is connected to said torsion element 10 on the side opposite the first steering shaft 7 on the rotation axis 8, which in turn ends in a steering gear 12. If the steering wheel 6 is turned with a torque in the form of a steering torque 13, the steering torque 13 is transferred accordingly via the steering shafts 7, 11 to the steering gear 12, which, in response, steers the front wheels 3 to drive in a curve with a wheel angle 14.

The steering process is supported by an auxiliary motor 15 which assists the second steering shaft 11 in turning. For this purpose, the torque sensor 9 detects the steering torque 13. The auxiliary motor 15 then steers the second steering shaft 11 inter alia according to the detected steering torque 13.

To detected the steering torque 13, the torque sensor 9 comprises a magnetic transmitter element 16 which is connected to the first steering shaft 7, and which induces a magnetic field 17. The torque sensor 9 further comprises a sensor chip 18 connected to the second steering shaft 11, which receives the magnetic field 17 from the magnetic transmitter element 16 as a function of a relative angular position of the first steering shaft 7 and thus of the magnetic transmitter element 16 to the second steering shaft 11, and thus to the magnetic filter 18, and forwards a measurement signal 20 dependent on the received magnetic field to an evaluation device 21. This determines the angular position between the two steering shafts 7, 11 based on the measurement signal 20 and outputs a sensor signal 19 dependent on this, which is thus also dependent on the steering torque 13 due to the elasticity of the torsion element 10. The sensor signal 19 is thus directly dependent on the steering torque 13 to be detected, so that the auxiliary motor 15 can process this information directly to turn the second steering shaft 11.

Reference is made to FIG. 2 which shows a first version of the torque sensor 9.

For the description of the torque sensor 9, a space is assumed in the cylindrical coordinate system which is spanned by an axial direction 22, a radial direction 23 and a peripheral direction 24. The axial direction 22 is aligned in the direction of the axis of rotation 8, while the peripheral direction 24 is aligned circumferentially around the axis of rotation 8. The radial direction 23 extends radially to the axis of rotation 8.

In this cylindrical coordinate system, the torque sensor 9 comprises a first bearing bush 25 extending around the axis of rotation 8 for force-fit reception of the first steering shaft 7, and a second bearing bush 26 for force-fit reception of the second steering shaft 11.

In this case, the first bearing bush 25 has a retaining member 27, here in the form of a flange, to which the magnetic field transmitter element 16 is attached, for example by means of an adhesive. In this way, the magnetic field transmitter element 16 is held stationary on the first steering shaft 7 when the latter is pressed into the first bearing bush 25.

A carrier 28, here also in the form of a flange, is formed on the second bearing bush 26. A printed circuit board holder 30 is held on the carrier 28 by means of a pin 29, which is supported on a floating bearing element 31 on the opposite side as seen in the axial direction 22. The evaluation device 21 in the form of a printed circuit board is accommodated in the printed circuit board holder 30, to which in turn the sensor chip 18 is electrically and mechanically connected, for example by soldering. The measurement transducer 20 from the sensor chip 18 is processed in the evaluation device 21 by means of electrical components 31, and forwarded as a sensor signal 19 to the auxiliary motor 15 via an interface that is not further visible in FIG. 2.

When the first steering shaft 7 is rotated during operation of the torque sensor 9, and the rotation is transmitted to the second steering shaft 11 via the torsion element 10, the first bearing bush 25, which is held in a force-fitting manner on the first steering shaft 7, rotates with the magnetic field transmitter element 16, and the second bearing bush 26, which is held on the second steering shaft 11, rotates with the sensor chip 18. Due to inertia of the second steering shaft 11 and the elasticity of the torsion element 10, the first steering shaft 7 twists relative to the second steering shaft 11 when the first steering shaft 7 is turned. As a result, the magnetic field transmitter element 16 also twists in relation to the sensor chip 18.

The magnetic field 17 of the magnetic field transmitter element 16 changes over the peripheral direction 24. Therefore, if the magnetic field transmitter element 16 rotates in relation to the sensor chip 18, the magnetic field 17 arriving at the sensor chip 18 changes. Since the rotation of the magnetic field transmitter element 16 relative to the sensor chip 18 is dependent on the magnitude of the steering torque 13 due to the elasticity of the torsion element 10, the magnetic field 17 arriving at the sensor chip 18, the measurement signal 20 and finally the sensor signal 19 are therefore also dependent on the magnitude of the steering torque 13.

In the embodiment of FIG. 2, the magnetic field transmitter element 16 is designed in the form of a magnetic ring which is guided circumferentially around the axis of rotation 8 at a radial ring distance 32. The sensor chip 18 is also arranged at a distance from the axis of rotation 8 with the radial ring distance 32, so that the magnetic field transmitter element 16 and the sensor chip 18 overlap radially. In FIG. 2, the centres of these elements in the extension of the radial direction 23 were selected as the reference point for determining the radial ring distance 32 of the sensor chip 18 and the magnetic field transmitter element 16.

In addition to the radial overlap, the magnetic field transmitter element 16 is arranged at an axial measuring distance 33 from the sensor chip 18 in FIG. 2.

If, due to mechanical tolerances, the first steering shaft 7 is offset in the radial direction 23 relative to the second steering shaft 11 during use and the torsion element 10 is thus subjected to shear stress, this has less effect on the magnetic field 17 arriving at the sensor chip 18 than if the sensor chip 18, as shown for example in EP 1 167 936 A2, is arranged at the same height in the axial direction 22 but spaced apart in the radial direction 23.

With reference to FIGS. 3 and 4, an alternative design of the torque sensor 9 will be described below.

In contrast to the embodiment in FIG. 2, the magnetic field transmitter element 16 in FIGS. 3 and 4 is not designed as a ring magnet but is straight and arranged tangentially to the axis of rotation. For this purpose, a particularly inexpensive bar magnet is selected as shape for the magnetic field transmitter element 16 in the present embodiment, which is indicated in a top view in FIG. 4 and is referred to as bar magnet 16 in the description of FIGS. 3 and 4.

The bar magnet 16 has a north pole 34 and a south pole 35, which are connected to each other at a pole transition point 36. From the point of view of the axis of rotation 8, the pole transition point 36 is arranged in such a way that it represents a perpendicular foot point for a perpendicular intersecting the axis of rotation 8 and the bar magnet 16.

Seen transversely to the radial direction 23, the bar magnet 16 has a first face side 38 and a second face side 39 opposite the first face side 38. The two face sides 38, 39 are connected to each other by a first longitudinal side 41 facing the axis of rotation 8 and a second longitudinal side 42 facing away from the axis of rotation 8.

If the first steering shaft 7 rotates relative to the second steering shaft 11 in the manner described above, the sensor chip 18 as seen from the bar magnet 16 moves along a circular path 44, which is indicated by a dashed line in the area of the bar magnet 16 in FIG. 4. The circular path 44 intersects the edge of the first face side 38 and the second face side 39, visible in the top view of FIG. 4, at an intersection point 45 each. Each intersection point 45 is spaced from the first longitudinal side 41 by an intersection point distance 46.

Finally, in the top view of FIG. 4, the bar magnet 16 is arranged so that the circular path 37 has an extreme point 47 in the area of the bar magnet 16 when viewed from the first longitudinal side 41. Each extreme point 47 is spaced from the second longitudinal side 42 by an extreme point distance 48.

The sensor chip 18 should be guided axially below the magnetic field transmitter element 16 in a magnetic field that is as homogeneous as possible. In this way, the steering torque 13 in the measurement signal 20 generated by the sensor chip 18 as a function of the movement of the bar magnet 16 on the circular path 44 is linearly dependent on the movement and can be technically evaluated in a particularly simple manner.

For this purpose, the intersection distances 46 should be between 5% to 45%, preferably between 15% to 35%, particularly preferably between 20% to 30% of a distance of the two longitudinal sides 41, 42. Both intersection distances 46 can, but do not have to be chosen equally. Furthermore, the extreme point distance 48 should be between 5% to 45%, preferably between 15% to 35%, particularly preferably between 20% to 30% of the distance of the two longitudinal sides 41, 42. The intersection point distances 46 should be selected between 10% and 90%, preferably between 30% and 70%, particularly preferably between 45% and 55% of the extreme point distance 48.

Finally, to achieve said linear dependence, the movement of the sensor chip 18 along the circular path 44 as seen by the bar magnet 16 should be restricted between two movement limiting points 49 spaced from the respective face sides 38, 39 by a face side distance 50 of between 5% to 45%, preferably between 15% and 35% and more preferably between 20% and 30% of the distance between the two face sides 38, 39.

FIGS. 5 and 6 show a third version of the torque sensor which can be used if the distance between the movement limiting points 49 on the bar magnet of FIGS. 3 and 4 is too short.

In the third version of the torque sensor 9, the magnetic field transmitter element is designed as a ring segment with several poles 34, 35 arranged in a row. The advantage here is that several sensor chips 18, 18′ can now be arranged for example for redundancy purposes.

1. A sensor for detecting a torque exerted on a torsion element and acting about an axis of rotation, the sensor comprising:
a transmitter element which can be mounted in a stationary manner relative to a first axial end of the torsion element and configured to output a transmitting field which can be varied in the peripheral direction about the axis of rotation,
a sensor chip configured to be mounted in a stationary manner relative to a second end opposite the first axial end of the torsion element and configured to output a measurement signal which is dependent on the transmitting field arriving at the sensor chip, and
an evaluation device which is configured to output a sensor signal dependent on the torque on the basis of the measurement signal,
wherein the sensor chip is arranged axially spaced and radially within the transmitter element, but eccentrically to the axis of rotation.

2. The sensor according to claim 1, wherein the transmitter element is a magnet which emits a magnetic field as the transmitting field, whereby the sensor chip is configured to output the measurement signal as a function of the magnetic field arriving at the sensor chip.

3. The sensor according to claim 2, wherein the magnet is formed with a rectilinear shape or with a circular shape and extends or is arranged tangentially to the axis of rotation.

4. The sensor according to claim 3, wherein the rectilinear shape of the magnet is the shape of a bar magnet or the circular shape of the magnet is the shape of a circular segment, each with a rectangular cross-section.

5. The sensor according to claim 4, wherein the sensor chip is movably arranged with respect to the bar magnet on a circular path leading around the axis of rotation, which, viewed axially, intersects end edges of the bar magnet with a distance of intersection from an edge of the bar magnet directed towards the axis of rotation, which is between 5% and 45% of a distance of the end edges.

6. The sensor according to claim 5, wherein the circular path, viewed axially in the region covering the bar magnet, has, from the point of view of an edge of the bar magnet directed towards the axis of rotation, an extreme point which is spaced from the edge of the bar magnet directed towards the axis of rotation by an extreme point distance of between 5% and 45%, of the distance between the edge of the bar magnet directed towards the axis of rotation and the edge of the bar magnet directed away from the axis of rotation.

7. The sensor according to claim 5, wherein a movement of the sensor chip on the circular path from the point of view of the bar magnet is limited between two movement limiting points, each of which has a face side distance from the face side edges of the bar magnet of between 5% and 45%, of a distance of the face side edges.

8. The sensor as claimed in one of the preceding claims 5, wherein a perpendicular foot point referred to the axis of rotation is arranged centrally on the bar magnet when the torque is zero.

9. The sensor as claimed in one of the preceding claims 6, wherein the circular path in the area of the bar magnet is symmetrical with respect to a straight line passing through the perpendicular foot point and the axis of rotation.

10. A vehicle, comprising:
a chassis movable in a driving direction,
two front wheels supporting the chassis at the front as viewed in the driving direction,
two rear wheels supporting the chassis at the rear as viewed in the driving direction,
a steering wheel for rotating a steering shaft about an axis of rotation for turning the front wheels,
a sensor as claimed in one of the preceding claims for detecting a torque exerted on the steering shaft with the steering wheel, and
a motor for adjusting the turning of the front wheels in accordance with the detected torque.
